(19) United States
(12) Patent Application Publication
(10) Pub. No.: US 2026/0204263 A1
(43) Pub. Date: Jul. 16, 2026

(54) SEPARATION OF CONVERSATIONAL CLUSTERS IN AUTOMATIC SPEECH RECOGNITION TRANSCRIPTIONS

(71) Applicant: GOOGLE LLC, Mountain View, CA (US)

(72) Inventors: Dimitri Kanevsky, Ossining, NY (US); Sagar Savla, San Francisco, CA (US); Artem Dementyev, Boston, MA (US)

(21) Appl. No.: 19/135,642

(22) PCT Filed: Dec. 6, 2022
(86) PCT No.: PCT/US2022/081016

§ 371 Date: Jun. 4, 2025

(51) Int. Cl. G10L 17/02; G06T 11/10; H04R 1/40; H04R 3/00

(52) U.S. Cl. CPC G10L 17/02; G06T 11/10; H04R 1/406; H04R 3/005; H04R 2201/401

(57) ABSTRACT

In various implementations, audio data that captures a spoken utterance of a first user and a spoken utterance of a second user is received. The audio data can be generated by microphone(s) of a transcription device. It can be determined, based on determining that the spoken utterance of the first user and the spoken utterance of the second user overlap for at least a threshold period of time, that the first user is a member of a first conversational cluster. The first conversational cluster includes at least one other participant and does not include the second user. A transcription can be generated based on performance of automatic speech recognition on the audio data and can include recognized text from the spoken utterance of the first user and can be annotated to indicate that such recognized text is part of the first conversational cluster.

### BACKGROUND

Speaker diarization is a branch of audio signal analysis that involves portioning an input audio stream into homogenous segments according to speaker identity. It answers the question of “who spoke when” in a multi-speaker environment. For example, speaker diarization can be utilized to identify that a first segment of an input audio stream is attributable to a first human speaker (without necessarily identifying who the first human speaker is), a second segment of the input audio stream is attributable to a disparate second human speaker, a third segment of the input audio stream is attributable to the first human speaker, etc.

An automatic speech recognition (ASR) engine may be used to process audio data that captures a spoken utterance of a user and generate ASR output, such as a transcription (i.e., a sequence of term(s) and/or other token(s)) of the spoken utterance. In some cases, speaker diarization may be used, for example, to enhance readability of an automatic speech transcription by indicating which parts of the transcription belong to each speaker identity.

In an example application, a user may use automatic speech transcriptions to aid in participating in conversations with other people. However, in environments where there are a plurality of people speaking, it may be difficult to follow the conversation(s) in the automatic speech transcription. This may particularly be the case in situations where multiple conversations are occurring in the environment. For instance, in this case, an automatic speech transcription may include spoken utterances relating to different conversations, such that a particular entry in the transcription may not relate to the preceding or subsequent entry (i.e., because it was said as part of a different conversation). Whilst speaker diarization could potentially help to enhance the readability of the transcription generally, many automatic real time transcription systems are not capable of indicating a change in speaker identity. Furthermore, different conversations captured in the transcription may still be intermingled.

In addition or alternatively, many real time speaker diarization systems that have been proposed for use in indicating changes in speaker identity in a real time transcription can suffer from one or more drawbacks. For example, some can fail to accurately differentiate between human speakers in various situations such as in noisy environments and/or when speaker(s) have similar voice characteristics. As another example, some can require utilization of a relatively large neural network model, which can require significant memory and/or processor resource(s) during utilization. This can be particularly problematic, for example, when such a neural network model is to be utilized by a client device, with limited resources, that is also performing ASR. For instance, some client devices can lack the resources to perform both ASR and speaker diarization utilizing a diarization neural network model and/or can utilize significant power resources in performing speaker diarization utilizing a diarization neural network model. As yet another example, some can be unable to indicate speaker identity for only a subset of speakers in an environment (e.g., provide a transcription and/or annotation(s) for only some of multiple speakers in an environment).

### SUMMARY

Techniques are described herein for providing an annotated automatic speech recognition transcription. Annotation of the transcription can be performed based on determining that the spoken utterance to be transcribed occurred within the context of a particular conversation. In particular, it can be determined that the user providing the spoken utterance is a member of a particular conversational cluster (e.g. a subset of persons in an environment who are engaging in a conversation) when providing the spoken utterance. This can be determined, for instance, by grouping speakers into conversational clusters, where speakers whose speech does overlap are less likely to be in the same conversational cluster, and speakers whose speech doesn't overlap are more likely to be in the same conversational cluster. The recognized text of the spoken utterance can then be associated with the particular conversation cluster, and the transcription can be annotated accordingly.

Techniques described herein give rise to various technical advantages and benefits.

For instance, by associating spoken utterances in the transcription with conversational clusters, readability of the transcription can be improved. As an example, when the transcription is viewed, it can be indicated which conversational cluster each spoken utterance in the transcription is associated with. For instance, entries in the transcription may be color-coded according to the associated conversational cluster and/or entries in the transcription may be grouped together based on the conversational cluster (e.g. all entries in “conversational cluster A” presented first, then all entries in “conversational cluster B”, etc.). As another example, separate transcriptions can be provided for each conversational cluster. In this way, a reader of the transcription(s) can more easily follow the conversation(s). This may be particularly beneficial in instances where a reader is trying to follow an ongoing conversation in real time (i.e., during the conversation as it is happening). Furthermore, in some cases, only spoken utterances from a subset of conversational clusters in the environment may be transcribed, output, and/or displayed. In this way, computational resources which would otherwise be consumed in transcribing, outputting, and/or displaying spoken utterances from conversational clusters which may not be of interest (e.g. from background conversations) can be conserved.

In an example implementation, a system may be provided that includes a transcription device. The transcription device may be, for instance, a mobile device associated with a first user. The transcription device can determine that there are a plurality of users present in the environment (e.g. via manual user input indicating the present users, by determining that speech has been previously received from a plurality of users, etc.). The transcription device can group the plurality of users into two or more conversational clusters. For instance, at least initially, it may be assumed that all of the users belong to a single conversational cluster (that is, the users are all participating in the same conversation). Over time, the participants of the conversation may splinter into a plurality (e.g. two or more) of separate conversations, and the participants of these conversations may be referred to collectively as conversational clusters. Thus, if some of the users are determined to speak at the same time as one another (e.g. because they are no longer participants of the same conversation), it may be determined that they are members of different conversational clusters. In some cases, users may move between conversational clusters, start new conversational clusters, and end existing conversational clusters over the duration of the transcription session.

As an example, in an environment, there may be present users 1 to 4. Initially, all of the users may be determined (or assumed) to be members of conversational cluster A. Over the course of the transcription session, one or more instances of “overlap” may be detected between user 1 and users 2 and 3. Instances of overlap between two users can be detected when it is determined that speech from each of the two users occurs at the same time, or “overlaps”. In some cases, an instance of overlapping can be determined when the speech of the two (or more) users is determined to overlap for at least a threshold period of time (e.g. to avoid false positives of overlapping speech which might occur during normal conversation between two participants of the same conversation). As such, it can be determined that user 1 is no longer a member of conversational cluster 1, and thus user 1 is instead determined to be a member of new conversational cluster B. In some cases, there may be a threshold number of instances of overlap which are detected before user 1 is determined to be a member of conversational cluster B. Similarly, one or more instances of “overlap” may be detected between user 4 and users 2 and 3. Thus it may be determined that user 4 is no longer a member of conversational cluster A, and is instead a member of conversational cluster B. In some cases, determining that user 4 is a member of conversational cluster B (and not, say, conversational cluster C) may be based on determining that there are less than a threshold number of instances of overlap detected between users 4 and 1. As such, it can be determined that user 4 is a member of conversational cluster B (along with user 1).

Following the above example, subsequently, one or more instances of overlapping may be detected between user 1 and users 3 and 4, as well as between user 2 and users 3 and 4. There may also be less than a threshold number of instances of overlap detected between users 1 and 2. As a result, it can be determined that user 1 and user 2 have formed a new conversational cluster (e.g. conversational cluster C). Similarly, one or more instances of overlapping may be detected between user 3 and users 1 and 2, as well as between user 4 and users 1 and 2. There may also be less than a threshold number of instances of overlap detected between users 2 and 3. Thus, it can also be determined that user 3 and user 4 have formed a new conversational cluster (e.g. conversational cluster D).

In some cases, in order to determine which user provided a particular spoken utterance, the transcription device can process the audio data to identify one or more voice characteristics present in the spoken utterance (e.g. as part of a speaker diarization process). The transcription device can then determine an identifier associated with the user based on the voice characteristics. Voice characteristics can be determined based on, for instance, processing the audio data using a speaker recognition model (e.g. a text independent speaker ID model). The speaker recognition model may be trained to provide an embedding indicative of one or more acoustic features of the speech in the audio data.

For instance, the transcription device may determine voice characteristics based on one or more initial spoken utterances from the user. The determined voice characteristics may then be taken as (or associated with) an identifier. Subsequent spoken utterances with the same voice characteristics (or within a threshold similarity), can then be associated with the same identifier.

As another example, the transcription device may retrieve (e.g. from storage of the transcription device, from a remote computing device, etc.) voice characteristics associated with the user (or an identifier associated with the user). Voice characteristics identified in the audio data can then be compared with the voice characteristics associated with the user.

Based on the comparison (e.g. if there is at least a threshold level of similarity), it can be determined that the spoken utterance in the audio data was provided by the user.

As another example, an identifier associated with the spoken utterance may be determined based on a signal received from a signaling device associated with the user whilst the spoken utterance is received from the user. The signal can be rendered by the signaling device responsive to the signaling device receiving an indication that the user is speaking. The signal may have attributes associated with the identifier (e.g. signals of a particular frequency may be associated with a particular identifier), and/or the signal may carry (e.g. via encoding) the identifier or information which can be used to retrieve the identifier (e.g. from storage of the transcription device or from a remote computing device). The identifier may be associated with a user in the environment (e.g. “user 1”), an identity of a user (e.g. “Steven”), the signaling device (e.g. “device 1”), etc. Use of a signal from a signaling device may enable speech to be attributed to respective speakers with greater certainty. Furthermore, by attributing spoken utterances in this way, typical computationally expensive speaker diarization need not be performed. As such, automatic speech recognition transcriptions may be accurately annotated for relatively low cost (e.g. in terms of computing resources, processing time, etc.). In some instances, this may allow for annotated transcriptions to be reliably provided in real time and/or to be generated on device(s) with limited resource(s).

In some implementations, the transcription may be rendered as output on one or more displays (e.g. of the transcription device). For instance, the transcription may be rendered in a streaming manner (e.g. in or close to real-time). Annotations in the transcript may be, for instance, represented by rendering one or more graphical elements (e.g. recognized text from a spoken utterance) with a color associated with a respective identifier, user, and/or conversational cluster. One or more attributes of the color, for instance intensity, may be based on the level of confidence. In cases where plural identifiers, users, and/or conversational clusters are associated with a particular section of recognized text (e.g. if there is insufficient information to determine whether the section of recognized text should be associated with a first or second conversational cluster), the text may be rendered to have a combination of colors associated with the plural identifiers, users, and/or conversational clusters. In some additional or alternative implementations, the transcription may be stored for later use.

In some implementations, the transcription device may determine positional information (e.g. a distance and/or direction) of the speaker and/or the signaling device relative to the transcription device. For instance, the transcription device may include a beamforming microphone array capable of determining a direction from which an audio signal is received. As another example, the signal provided by a signaling device may include information indicative of a direction and/or distance between the signaling device and the transcription device (e.g. time distance of arrival (TDOA) localization information). As another example, the a signaling device may determine positional information based on sensor data (e.g. data captured by one or more of an inertial measurement unit (IMU), an accelerometer, global positioning system (GPS) data, etc.). The positional information may be used, for instance, to determine whether or not to perform automatic speech recognition on a particular spoken utterance, whether the spoken utterance should be annotated as being associated with an user (or identifier), whether a spoken utterance should be associated with a particular conversational cluster, etc. In some additional or alternative implementations, the transcription may be annotated to indicate the positional information associated with a particular spoken utterance. This may further enhance the readability of the transcription, and allow a user of the transcription to more easily follow the conversation(s) being transcribed.

### BRIEF DESCRIPTION OF THE DRAWINGS

FIGS. 1A, 1B, and 1C depict scenarios in example environments that demonstrate various aspects of the present disclosure, in accordance with various implementations.

FIG. 2 depicts a flowchart illustrating an example method of generating an annotated transcription, in accordance with various implementations.

FIGS. 3A and 3B depict various non-limiting examples of user interfaces utilized in rendering an annotated transcription, in accordance with various implementations.

FIG. 4 depicts an example method for practicing selected aspects of the present disclosure.

FIG. 5 schematically depicts an example architecture of a computer system.

### DETAILED DESCRIPTION

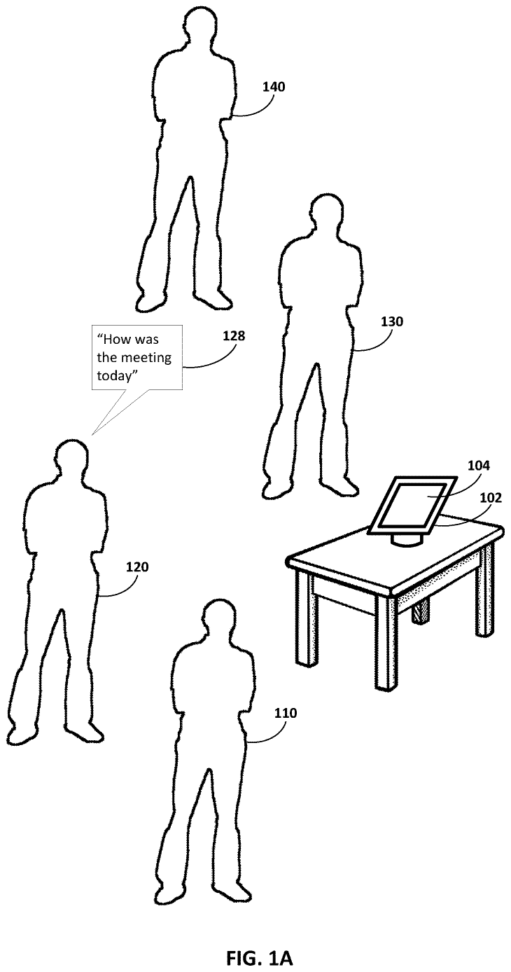

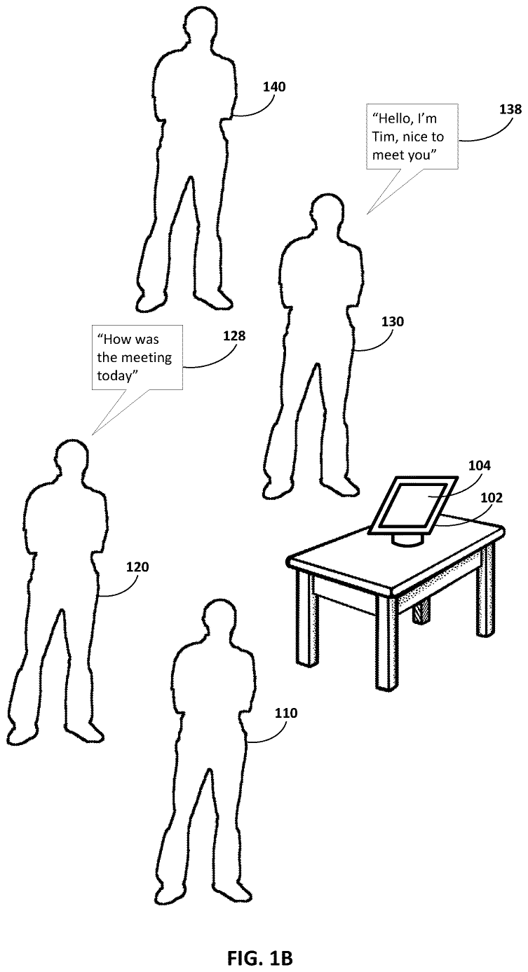

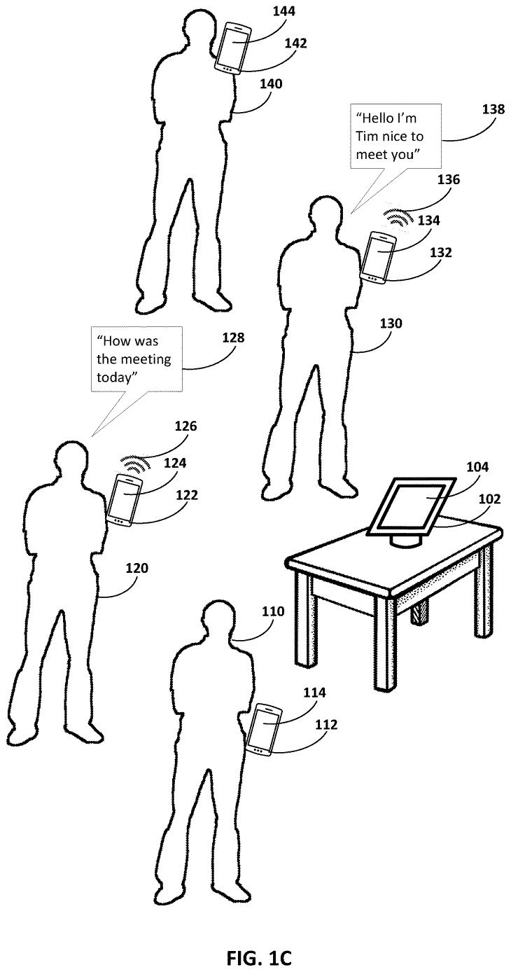

FIG. 1A depicts a scenario in an example environment that demonstrates various aspects of the present disclosure, in accordance with various implementations. The environment includes a plurality of users 110, 120, 130, 140 engaging in a conversation.

Although a first user 110, a second user 120, a third user 130, and a fourth user are depicted in FIG. 1A, it will be appreciated that the system may operate with any number of users. In addition, although a single transcription device 102 is depicted in FIG. 1A, it will be appreciated that there may be a plurality of transcription devices 112, and each transcription device 102 may not be associated with any particular user, or may be associated with any number of users.

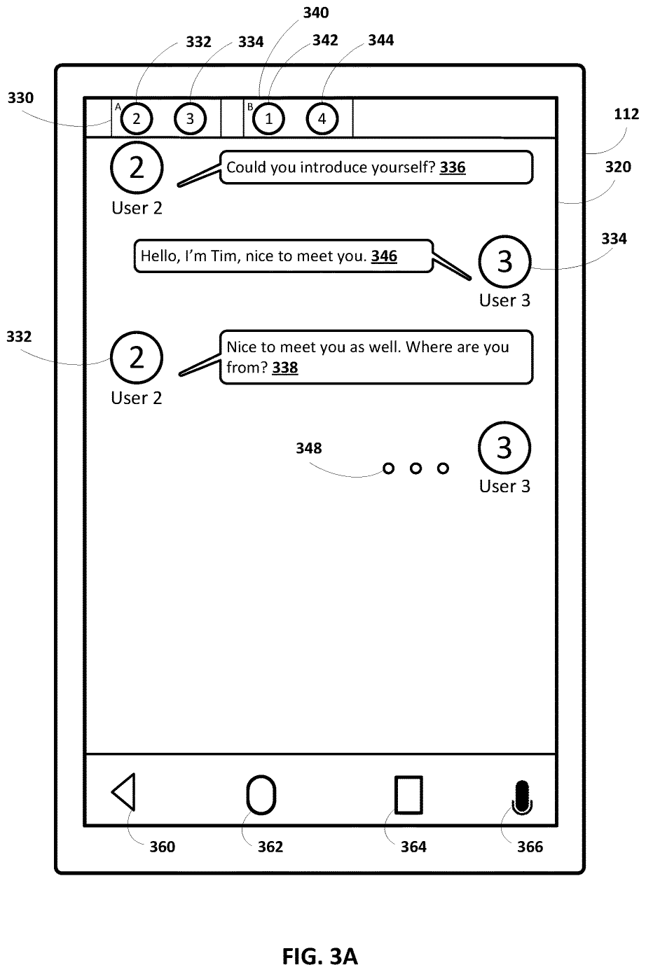

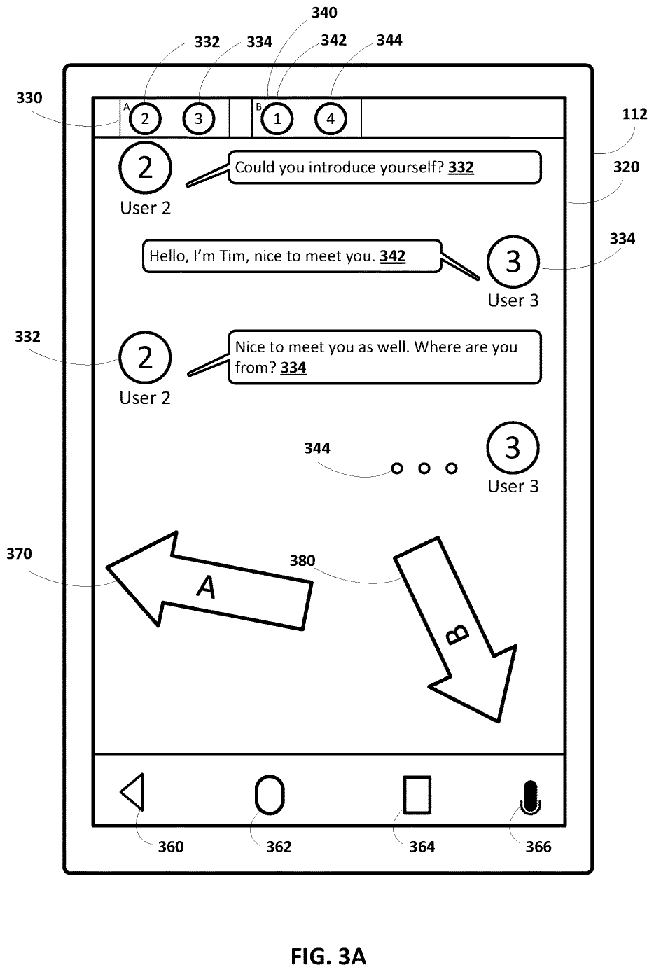

As depicted in FIG. 1A, the transcription device 102 may be provided as a desktop computer. However, it will be appreciated that the transcription device 102 is not limited to this and may be provided as any suitable type of computing device, such as a mobile device, a laptop computer, a tablet computer, a conferencing system, a wearable device such as a smart watch, earphones, a headset, smart glasses, a badge device, etc. In some implementations, the transcription device 102 may include a display 104. The display 104 can output the annotated transcription, for instance, via a user interface (such as user interface 320 depicted in FIGS. 3A and 3B). In some implementations, the display 104 may be touch sensitive to allow for user input. The transcription device 102 includes one or more microphones. The one or more microphones can be used to detect sounds occurring in the environment (e.g. a spoken utterance 128 from the second user 120, background noise, etc.) and responsively generate audio data. The transcription device 102 may additionally include one or more input and/or output interfaces to enable a user to interact with the transcription device 102 (e.g. keyboard, mouse, hardware speakers, etc.). In some implementations, one or more operations described as being performed by the transcription device 102 can be performed by a remote computing device (e.g. a server). In addition, in some implementations, the transcription device 102 may not include a display 104. As such, the transcription device can provide the annotated transcription to another device for display, perhaps at a later time (i.e., not in real time).

In FIG. 1A, it may be assumed that the four users depicted together form a single conversational cluster (i.e., they are all involved in the same conversation such that, for instance, spoken entries to the conversation are taken in turn, and spoken entries generally relate to the preceding and subsequent spoken entries). For instance, as depicted in FIG. 1A, the second user 120 provides a spoken utterance 128 of “How was the meeting today”. Since the other users are in the same conversational cluster, they do not provide a spoken utterance which may overlap with the spoken utterance 120 of the second user.

FIG. 1B depicts another scenario in an example environment that demonstrates various aspects of the present disclosure, in accordance with various implementations. The scenario depicted in FIG. 1B is largely the same as described with reference to FIG. 1A. However, in FIG. 1B, it may be assumed that the first user 110 is in a conversational cluster with the second user 120. It may further be assumed that the third user 130 is in communication with the fourth user 140. For instance, as depicted in FIG. 1B, the second user 120 provides the spoken utterance 128 “How was the meeting today”. The spoken utterance 128 from the second user 120 may be directed towards the first user 110. At approximately the same time (such that the two spoken utterances overlap, at least in part), the third user 130 provides the spoken utterance 138 “Hello, I'm Tim, nice to meet you”. The spoken utterance 138 may be directed to the fourth user.

As described herein, the transcription device 102 can determine that the first user 110 and the second user 120 are in a conversational cluster together. The transcription device can determine that the third user 130 and the fourth user 140 are in a conversational cluster together. As such, the transcription device 102 can, for instance, provide separate transcripts for each of the conversational clusters. In this way, a user can more easily follow the transcript of each conversation occurring in the environment. Furthermore, in some implementations, the transcription device 102 can dynamically update the determined conversational clusters throughout a transcription session. For instance, at a first time, the transcription device 102 can determine that each of the users are in a single conversational cluster (e.g. as depicted in FIG. 1A). At a second time, the transcription device 102 can determine that the conversational cluster has splintered in to a plurality of conversational clusters (e.g. as depicted in FIG. 1B).

FIG. 1C depicts another scenario in an example environment that demonstrates various aspects of the present disclosure, in accordance with various implementations. The scenario depicted in FIG. 1C is similar to that described with reference to FIG. 1B. However, as depicted in FIG. 1C, the first user 110 may be associated with a first signaling device 112, the second user 120 may be associated with a second signaling device 122, the third user 130 may be associated with a third signaling device 132, and the fourth user may be associated with the fourth signaling device 142. It will be appreciated that although each user present in the environment is depicted as being associated with a signaling device, there may be any number of signaling devices present in the environment, and each may be associated with any number of users.

As depicted in FIG. 1C, the signaling devices may be provided as mobile devices. However, it will be appreciated that the signaling devices are not limited to this and may be provided as any type of suitable device, such as a desktop computer, laptop computer, tablet computer, etc. In some implementations, the signaling device 122 may be provided as a wearable device such as a smart watch, earphones, a headset, smart glasses, a badge device, etc. In addition, each of the signaling devices 112, 122, 132, 142 in the environment may be of the same type, or may be of different types.

The signaling devices 112, 122, 132, 142 may each include displays 114, 124, 134, 144. In some implementations, the signaling devices 112, 122, 132, 142 may be capable of operating in a similar way as described for the transcription device 102. For instance, one or more of the signaling devices 112, 122, 132, 142 may render the annotated transcription on the respective displays 114, 124, 134, 144 via a user interface (e.g. the user interface 320 as described in relation to FIGS. 3A and 3B).

The signaling devices can receive an indication that an associated user is speaking. For instance, as depicted in FIG. 1C, the second user 120 can provide the spoken utterance 128 of “How was the meeting today”, and the second signaling device 122 can responsively receive an indication that the second user 120 is speaking.

The indication of the user speaking can be received based on the signaling device processing sensor data. The sensor data may be captured by sensors of the signaling device 122. For instance, the sensors may capture sound data including a spoken utterance, image data capturing the user's mouth moving, infrared data capturing the user's mouth moving, vibration data from the user's body (e.g. face, neck, chest, etc.) indicative of the user 120 speaking, etc. The sensor data may be captured by any type of suitable sensor, such as a microphone, a camera, an infrared camera, an inertial measurement unit (IMU), an accelerometer, etc.

In some implementations, the environment includes one or more auxiliary devices (not shown). An auxiliary device can be in communication with a respective signaling device. The auxiliary device can provide sensor data to the respective signaling device. The sensor data can be used to determine whether or not a user is speaking. Additionally or alternatively, the auxiliary device can process the sensor data to determine whether a user is speaking. Responsively, the auxiliary device can provide to the signaling device the indication that the user is speaking. The auxiliary device may be, for instance, a wearable device such as a smart watch, earphones, a headset, smart glasses, a badge device, etc. In this way, the auxiliary device may be of a form more suitable for detecting whether a user is speaking (e.g. a wearable device such as earphones), allowing for conventional devices to be used as a signaling device (e.g. a smartphone).

Responsive to receiving the indication of a user speaking, a respective signaling device can render a signal associated with an identifier. For example, as depicted in FIG. 1C, the second user 120 can provide the spoken utterance 128 of “How was the meeting today”, and the second signaling device 122 can responsively receive an indication that the second user 120 is speaking. Responsive to receiving the indication that the second user 120 is speaking, the second signaling device 122 can render a first signal 126 associated with a first identifier.

Similarly, the third user 130 can provide the spoken utterance 136 of “Hello, I'm Tim nice to meet you”, and the third signaling device 132 can responsively receive an indication that the third user 130 is speaking. Responsive to receiving the indication that the third user 130 is speaking, the third signaling device 132 can render a second signal 136 associated with a second identifier.

The signal rendered by a signaling device can be associated with a particular identifier by virtue of having one or more particular attributes (e.g. frequency) which are associated with the identifier. Additionally or alternatively, the signal 126 can carry (e.g. using digital encoding) identification information which can be used to identify the identifier. In some implementations, the signal can also carry additional information regarding the user and/or the user device (e.g. positional information such as a relative direction and/or distance from the transcription device 102, for instance via TDOA localization information). The signal 126 may be rendered, for instance, as an audio signal (e.g. via one or more loudspeakers of the signaling device 122), or as a visual signal (e.g. via one or more LEDs of the signaling device 122). The identifier can be associated with, for instance, the user 120 providing the spoken utterance (e.g. “user 2”), an identity of the user 120 (e.g. “Tim”), a user account associated with the user 120, the signaling device 122 providing the signal 126 (e.g. “signaling device 1”), etc.

In some implementations, the identifier with which the signal is associated can be known to the signaling device in advance of the transcription session. For instance, the identifier may be predetermined by the manufacturer of the signaling device, or may be set by a user ahead of time. Additionally or alternatively, the identifier can be determined based on information received from another device (e.g. transcription device 102 or a remote computing device). For instance, user account information associated with a particular user may be provided to the signaling device. As another example, the identifier can be determined based on information provided during the transcription session. For instance, at the beginning of the transcription session, users may provide identifying information (e.g. a name, an ID number, etc.) to signaling devices 122, 132 and/or transcription devices 112, which can then be stored and/or distributed. The provided identifying information can then be associated with the users, and provided in the annotated transcription.

In this way, when the transcription device receives a signal whilst receiving a spoken utterance (e.g. continuously during the extent of the spoken utterance, intermittently whilst receiving the spoken utterance, at a beginning and/or end of the spoken utterance, etc.), the spoken utterance recorded by the transcription device 102 can be associated with an identifier (e.g. the user that provided the spoken utterance). The identifiers can be associated with conversational clusters (as described herein), such that the conversational cluster to which a spoken utterance belongs can be determined.

In some implementations, the identifier associated with a spoken utterance can additionally or alternatively be determined in other ways which do not require a signal rendered by a signaling device (e.g. using voice characteristics present in the audio data capturing the spoken utterance).

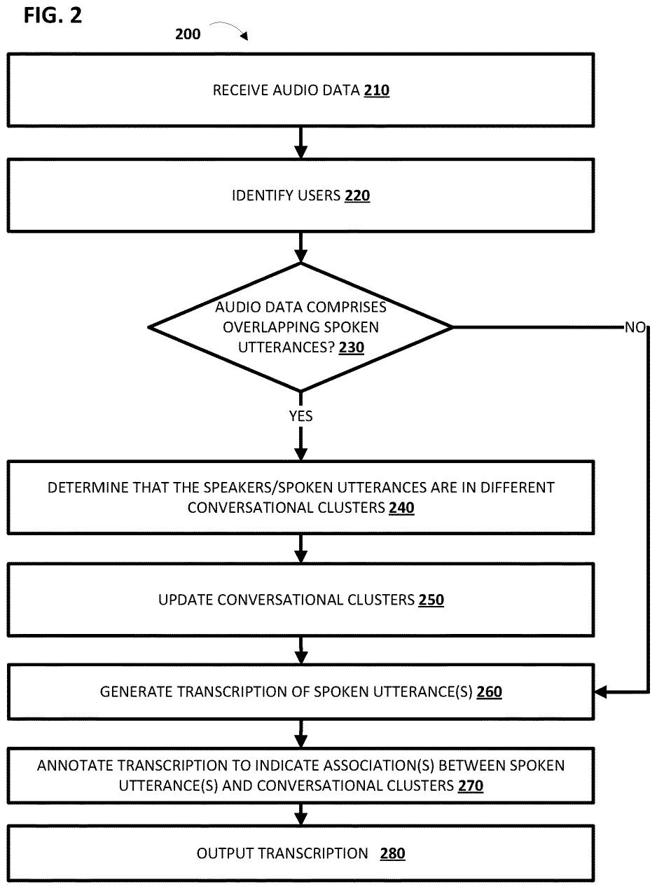

FIG. 2 depicts a flowchart illustrating an example method of generating an annotated transcription, in accordance with various implementations.

In block 210, the transcription device receives audio data. One or more microphones of the transcription device capture sound occurring in the environment. Responsively, the audio data is generated by the one or more microphones of the transcription device 112.

In some implementations, the one or more microphones of the transcription device can include a plurality of spatially distributed microphones (e.g. a beamforming microphone array). The transcription device can determine, based on a relative signal strength of the received audio data received at each one of the plurality of spatially distributed microphones, positional information (e.g. direction) of the source of the audio data. Positional information of a particular conversational cluster can be determined based on determined positional information of participants of the conversational cluster (e.g. a mid-point of the determined positional information of the participants of the conversational cluster, a selected participant's positional information, etc.). This information can be used to, for instance, focus the listening of the microphones of the transcription device 112 in the direction of a user or conversational cluster such that background noise (or other conversational clusters) can be minimized in the audio data. Alternatively or additionally, the determined positional information can be used to determine whether to process and/or display received spoken utterances. For instance, spoken utterances received from a direction different (e.g. greater than a threshold difference) to a known direction of a conversational cluster (e.g. based on a determined direction of prior speech and/or on a determined direction of a signal rendered by a signaling device) may not be further processed. This may prevent background speech and/or speech from conversational clusters not of interest to the user from being presented in the transcription, and thus resources which would otherwise be consumed in doing so can be conserved. As another example, the determined direction may be indicated in the annotated transcription, as described herein.

In block 220, the transcription device identifies one or more users whose speech is present in the audio data. This may be performed in any suitable way. For instance, as described herein, the user can be identified using voice characteristics present in the audio data capturing the spoken utterance from the user. As another example, the user (or an identifier) can be identified based on receiving a signal associated with the user (or the identifier) along with the spoken utterance from the user. If it is determined that the audio data does not include spoken utterances from any users, the transcription device can continue monitoring for spoken utterances.

In block 230, the transcription device determines whether the audio data captures an instance of overlap. Instances of overlap between two (or more) users can be detected when it is determined that speech from each of the users occurs at the same time, or “overlaps”. In some cases, an instance of overlap can be determined when the speech of the two users is determined to overlap for at least a threshold period of time (e.g. to avoid false positives of overlapping speech which might occur during normal conversation between two participants of the same conversation). If it is determined that the audio data does capture an instance of overlap between two or more of the users detected in the audio data, the operation may proceed to block 240.

If the audio data does not include spoken utterances which overlap (for instance, at least for a threshold period of time), it can be determined that the audio data does not capture an instance of overlap. Further, if it is determined that the audio data includes spoken utterances from only a single user (in block 220), it may be assumed that the audio data does not capture an instance of overlap. If it is determined that the audio data does not capture an instance of overlap, the operation may proceed to block 260, without updating the conversational clusters. In some implementations, the fact that the user(s) identified in the audio data do not overlap one another (e.g. for the threshold period of time required to detect an instance of overlap, or a different (e.g. shorter) threshold period of time) may be used as an indication that the user(s) are participants of the same conversational clusters. For instance, this information may be used to improve confidence of the current estimated conversational clusters, and/or to update which users should be associated with which conversational clusters.

In block 240, the transcription device determines that the users involved in the detected instance of overlap are in different conversational clusters. In some implementations, there may be a threshold number of instances of overlap which are detected before users are determined to be in different conversational clusters. In some implementations, positional information of the users (e.g. a direction or distance relative to the transcription device) may also be used to determine that the users are in different conversational clusters. For instance, users close together (e.g. within a threshold distance of one another) may be considered to be more likely to be in the same conversational cluster, and users remote from one another (e.g. greater than a threshold distance away from each other) may be considered to be more likely to be in different conversational clusters.

In block 250, the pairings between users and conversational clusters are updated. For instance, the pairings can be updated to take account of the users detected in the audio data who are now considered to be members of different conversational clusters. The spoken utterances in the audio data from the users detected in the audio data (and subsequent spoken utterances from the users in the audio data) can thus be assumed to be associated with the conversational clusters according to the updated pairings. In some instances, it may be determined that previously recorded spoken utterances should be associated with conversational clusters according to the updated pairings. For instance, it may take at least some time to allow for sufficient opportunities for participants of different conversational clusters to overlap one another, and thus for it to become clear which users are members of which conversational clusters. As such, once it is determined that a user is a member of a particular conversational cluster, it may be assumed that they have been a member of that conversational cluster for at least some time. Prior spoken utterances (e.g. received prior to the determination that the user is a member of the particular conversational cluster) may thus be associated with the particular conversational cluster.

In block 260, the transcription device generates a transcription of the spoken utterance(s). Generating the transcription can be based on performance of automatic speech recognition on the audio data (e.g. using a speech-to-text model). The transcription device can determine, using one or more speech recognition models, recognized text corresponding to the spoken utterance(s) in the audio data. The generated transcription can thus include the recognized text from the spoken utterance(s) of the user(s). In some implementations, knowledge of the user(s) can be used in the generation of the transcription of the spoken utterance(s). For instance, the identifier may enable attributes of the speaker of a particular spoken utterance (e.g. accent, speech impediments, etc.) to be determined. These attributes of the speaker of the spoken utterance can then be taken into account when generating the transcription of the spoken utterance.

In block 270 the transcription is annotated. The transcription can be annotated to indicate that the recognized text of the spoken utterance(s) is associated with a particular conversational cluster. The transcription can also be annotated to indicate that the spoken utterance(s) is associated with a particular user (or identifier). The transcription may include a plurality of spoken utterances from the users in the environment (e.g. over the course of the transcription session). In this case, the transcription can be annotated to indicate the conversational cluster that each spoken utterance is associated with. In some implementations, the transcription may be annotated to indicate additional information about a user and/or a signaling device associated with the user. For instance, the transcription may be annotated to indicate a determined direction and/or distance from which the audio data and/or a signal rendered by the signaling device was received.

In block 280, the annotated transcription is output by the transcription device. For instance, referring back to FIGS. 1A, 1B and 1C, the transcription device 102 can render the annotated transcription on the display 104 of the transcription device 102. Additionally or alternatively, the transcription device can provide the annotated transcription for display by one or more other devices, such as a signaling device or another computing device. The annotated transcription may be rendered in a streaming manner. For instance, the annotated transcription may be rendered on the display device during a transcription session with minimal delay (e.g. in or near to real time), such that a user viewing the annotated transcription as it is being rendered can follow the conversation(s) occurring in the environment as they are occurring. In some implementations, the transcription device can store the annotated transcription (or provide the annotated transcription for storage by one or more other devices, such as signaling device, signaling device, a remote computing device, etc.), for later viewing.

In some implementations, one or more graphical elements (such as the recognized text from a spoken utterance of a user) are rendered to include a color associated with the conversational cluster to which the spoken utterance is deemed to belong. Additionally or alternatively, one or more graphical elements can be rendered to include a color associated with the user (or the identifier) who provided the spoken utterance. As an example, text recognized from speech which was part of a first conversational cluster may be rendered in a red color, and text recognized from speech which was part of a second conversational cluster may be rendered in a blue color. In some cases, text recognized from speech which is not associated with any particular conversational cluster and/or user (e.g. because the speech was received without a corresponding signal from a signaling device) may be rendered in a particular color (e.g. gray), or may not be rendered at all.

In some implementations, a confidence that the spoken utterance of the user is associated with a particular conversational cluster and/or identifier can be determined. For instance, there may not be sufficient information to determine whether a particular user (and thus spoken utterances provided by that user) is associated with a particular conversational cluster at a given moment in time (e.g. because early on in a conversation(s) there may not have been sufficient opportunities for a user to speak at the same time as each other user in the environment). As another example, if the user who provided the spoken utterance is determined based on voice characteristics using a speaker diarization model, the model may provide statistical likelihoods that a spoken utterance was received from a particular user, on which a confidence may be based.

In some cases, positional information relating to a spoken utterance and/or a signal rendered by a signaling device may be used in determining the confidence that the spoken utterance of the user is associated with the conversational cluster and/or identifier. For instance, if it is determined that the direction from which the spoken utterance is received is significantly different (i.e., greater than a threshold difference) than a determined direction of a conversational cluster (which can be determined, for instance, based on the direction of previous spoken utterances associated with the conversational cluster), there may be a low confidence that the spoken utterance should be associated with the conversational cluster (e.g. because the spoken utterance may be being provided by a person other than the user determined to be a participant of the conversational cluster).

The transcription can be annotated to indicate a determined confidence. As such, when output, one or more graphical elements (e.g. recognized text in the transcription) can be rendered to indicate the confidence that the recognized text belongs to a particular conversational cluster and/or identifier. For instance, the confidence can be used to determine an intensity of color, and the one or more graphical elements can be rendered with the color at the determined intensity of color. Following the earlier example, if the confidence that a particular passage of recognized text is associated with a conversational cluster is 80%, the system may cause the particular passage of text to be rendered in the red color with an intensity of 80%. Although intensity of color is provided as an example here, it will be appreciated that the confidence may be presented in any suitable way.

In some implementations, it may be determined that there is a possibility that a particular spoken utterance was received from more than one conversational cluster (and/or user). For instance, it may be determined that there is a chance that the spoken utterance was received from a first conversational cluster, and a chance that the spoken utterance was received from a second conversational cluster. In this case, it may not be possible to associate a single conversational cluster (and/or user) with the spoken utterance. As such, the system may cause the color of one or more graphical elements (e.g. the recognized text resulting from the spoken utterance) to be rendered with a color determined from a combination of the colors associated with the different conversational clusters (and/or users). Following the example above, in the event that the spoken utterance is associated with both the first conversational cluster and the second conversational cluster, the recognized text of the spoken utterance may be rendered to have a color which is a combination of red and blue. In some implementations, the contribution of each of the colors in the combination of colors may be determined based on a confidence that the spoken utterance is associated with a particular conversational cluster (and/or user).

In some implementations, additional information about the conversational cluster, the user, and/or a signaling device associated with the user may be rendered. For instance, information associated with the identity of the conversational cluster, the user, and/or the signaling device may be rendered along with corresponding recognized text (for instance, as depicted in FIGS. 3A and 3B). As another example, an indication of a determined direction and/or distance of the conversational cluster, the user and/or the signaling device may be presented (for instance, as depicted in FIG. 3B).

Although operations are generally described herein as being performed by the transcription device or a signaling device in the environment, it will be appreciated that one or more operations can be performed by other devices, such as one or more remote computing devices (e.g. servers, cloud computers, etc.), or can be distributed among plural devices. For instance, although the transcription device is described as performing automated speech recognition on the audio data to determine recognized text corresponding to a spoken utterance in the audio data, in some implementations, this may be performed by one or more remote computing devices. In this way, at least some tasks (e.g. the more computationally intensive tasks) can be outsourced to other devices, which may have more available computing resources. This may improve the speed of the techniques described herein (e.g. allowing for real time rendering of the annotated transcription), and/or reduce the resource requirements of the transcription device and/or a signaling device.

FIGS. 3A and 3B depict various non-limiting examples of user interfaces utilized in rendering an annotated transcription, in accordance with various implementations.

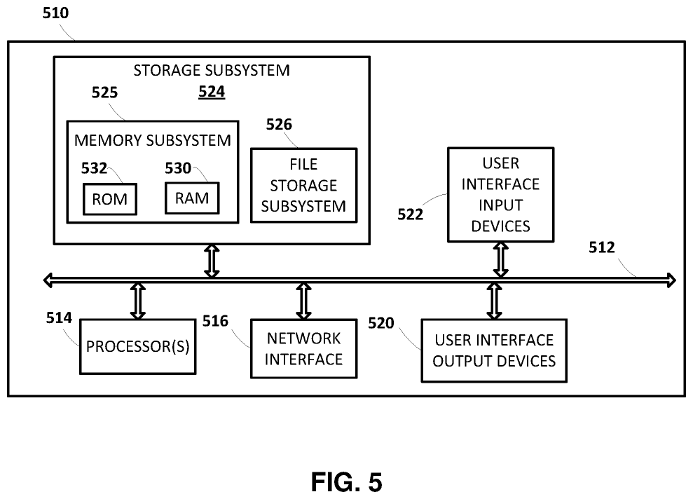

Referring to FIGS. 3A and 3B, various non-limiting examples of user interfaces utilized in rendering an annotated transcription, in accordance with various implementations, are illustrated. The transcription device 102 of FIGS. 1A to 1C is depicted and includes the user interface 320. Although the techniques of FIGS. 3A and 3B are depicted as being implemented by the transcription device 102 of FIG. 1, it should be understood that this is for ease in explanation only and is not meant to be limiting. For example, the techniques of FIGS. 3A and 3B can additionally and/or alternatively be implemented by one or more other devices (e.g., signaling devices 112, 122, 132, 142 of FIG. 1C, computer system 510 of FIG. 5, computing devices of other users, and/or other computing devices). This may be the case, for instance, if the transcription is stored and viewed at a later time. The user interface 320 of the transcription device 102 includes various system interface elements 360, 362, 364 (e.g., hardware and/or software interface elements) that may be interacted with by the first user 110 to cause the transcription device 102 to perform one or more actions. Further, the user interface 320 of the transcription device 102 enables the first user 110 to interact with content rendered on the user interface 320 by touch input (e.g., by directing user input to the user interface 320 or portions thereof) and/or by spoken input (e.g., by selecting microphone interface element 366—or just by speaking without necessarily selecting the microphone interface element 366 (i.e., an automated assistant executing at least in part on the transcription device 102 may monitor for one or more terms or phrases, gesture(s) gaze(s), mouth movement(s), lip movement(s), and/or other conditions to activate spoken input)).

In some implementations, the user interface 320 of the transcription device 102 can include graphical elements identifying each of the participants in a given conversational cluster and/or the environment. The participants can be identified in various manners, such as any manner described herein (e.g., receiving signals associated with identifiers along with the spoken utterances from participants, using voice characteristics to distinguish between users' voices, etc.). Similarly, the user interface 320 can include graphical elements identifying the various conversational clusters in the environment. As depicted throughout FIGS. 3A and 3B, graphical element 332 corresponds to the second user 120, graphical element 334 corresponds to the third user 130, graphical element 342 corresponds to the first user 110 and graphical element 344 corresponds to the fourth user 140. As also depicted throughout FIGS. 3A and 3B, graphical element 330 corresponds to the first conversational cluster, which includes the second user 120 and the third user 130, and graphical element 340 corresponds to the second conversational cluster, which includes the first user 110 and the fourth user 140. In some versions of those implementations, these graphical elements that identify participants and/or conversational clusters in the environment can be visually rendered along with corresponding transcriptions of user spoken input of participants in the conversation. In some additional and/or alternative versions of those implementations, these graphical elements that identify participants and/or conversational clusters in the environment can be visually rendered at a top portion of the user interface 320 of the transcription device 102. Although these graphical elements are depicted as being visually rendered at the top portion of the user interface 320 of the transcription device 102, it should be noted that is not meant to be limiting, and that these graphical elements can be rendered on a side portion of the user interface 320 or a bottom portion of the user interface 320. In some implementations, the participants in the conversation (and their corresponding spoken utterances) and/or the conversational clusters may be additionally or alternatively represented by rendering one or more graphical elements (e.g. the recognized text of the participants' spoken utterances, graphical elements 330, 332, 334, 340, 342, 344, etc.) in particular colors associated with the participants and/or the conversational clusters respectively.

Referring initially to FIG. 3A, the annotated transcription can be rendered on the user interface 320 of the transcription device 102 over the course of the transcription session. For example, the transcription device 102 can detect the spoken input 336 (which may also be referred to as a spoken utterance) of “Could you introduce yourself?”. The transcription device 102 can determine that the spoken input 336 was provided by the second user 120, for instance, based on voice characteristics of the spoken input 336, or based on receiving the spoken input 336 along with a signal associated with an identifier indicating that the second user 120 provided the spoken input 336. Responsively, the spoken input 336 can be rendered at the transcription device 102 along with the graphical element 332 corresponding to the second user 120. Subsequently, the transcription device 102 can detect spoken input 346 from the third user 130 of “Hello, I'm Tim, nice to meet you”. The transcription device 102 can determine that the spoken input 346 was provided by the third user 130 in much the same way as described above in relation to the spoken input 336. Responsively, the spoken input 346 can be rendered at the transcription device 102 along with the graphical element 334 associated with the third user 130. Further, the second user 120 can provide another spoken input 338 of “Nice to meet you as well. Where are you from?”, which can also be rendered at the transcription device 102. As the transcription device 102 detects further spoken input from the third user 130 an indication that the further spoken input is incomplete may be provided (e.g. by ellipses 348).

At the same time as the transcription device 102 transcribing and displaying spoken inputs 336 and 338 from the second user 120 and user input 346 from the third user 130, the transcription device 122 may also receive one or more spoken inputs from the first user 110 and/or the fourth user 140. Since the first user 110 and the fourth user 140 are determined to be in a different conversational cluster to the second user 120 and the third user 130 (as depicted by graphical elements 330 and 340), the transcription device 102 may refrain from displaying the user input(s) from the first user 110 and/or the fourth user 140 on user interface 320. In some implementations, selection of the graphical element 340 may cause the spoken inputs associated with the second conversational cluster to be displayed (that is, spoken inputs from the first user 110 and the fourth user 140 can be displayed). Subsequent selection of the graphical element 330 may then cause spoken inputs associated with the first conversational cluster to be displayed, as depicted in FIG. 3A. In some implementations, spoken inputs associated with the second conversational cluster may be displayed at the same time as the spoken inputs associated with the first conversational cluster. For instance, the spoken inputs associated with the second conversational cluster may be distinguished from the spoken inputs associated with the first conversational cluster by means of color coding, position on the user interface 320 (e.g. the spoken inputs associated with the second conversational cluster may be displayed away from the spoken inputs associated with the first conversational cluster, in a separate window rendered in the user interface 320, etc.), by one or more graphical elements, etc.

In some implementations, an indication of positional information relating to a given user and/or a conversational cluster can be provided. For instance, the direction from which a given spoken input and/or a signal from a signaling device is received can be provided. For example, as depicted in FIG. 3B, a first shape 370 and a second shape 380 can indicate a determined direction relating to the first conversational cluster and the second conversational cluster respectively. Although the shapes shown in FIG. 3B are arrow shapes, it will be appreciated that any shape could be used, for instance, a circular shape along an edge of the user interface 320 could be used to indicate a determined position. The shapes 370, 380 may, for instance, appear only whilst a user from a respective conversational cluster is speaking. As another example, the shapes 370, 380 may remain visible even when the users are not speaking. Further, although the shapes 370, 380 are shown as being separate from the transcribed user inputs 332, 342, 334, in some cases, they may be presented together as a single graphical element.

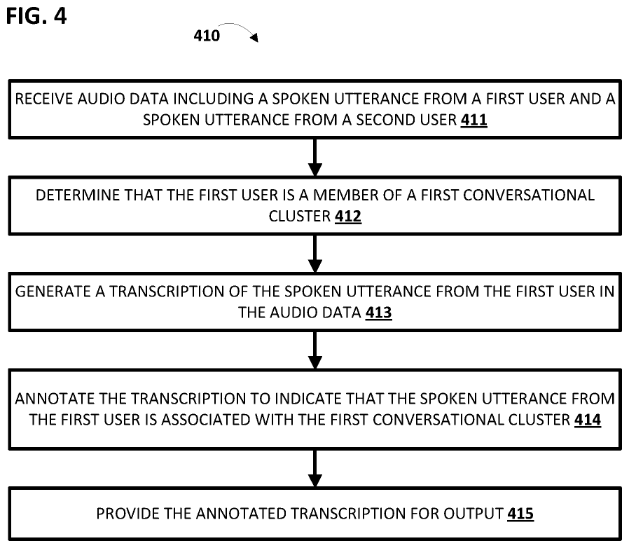

FIG. 4 depicts an example method for practicing selected aspects of the present disclosure. For convenience, the operations of the flowchart are described with reference to a system that performs the operations. This system may include various components of various computer systems. For instance, some operations may be performed at transcription device 102, while other operations may be performed by one or more components of a remote computing system. Moreover, while operations of method 410 are shown in a particular order, this is not meant to be limiting. One or more operations may be reordered, omitted or added.

At block 411, the system receives audio data that captures a spoken utterance of a first user and a spoken utterance of a second user. The audio data is generated by one or more microphones of a transcription device.

In some implementations, the system determines that the spoken utterance of the first user is provided by the first user based on one or more voice characteristics of the spoken utterance.

In some implementations, the system determines that the spoken utterance of the first user is provided by the first user based on one or more additional signals received by the transcription device. For instance, the system can receive, whilst receiving the audio data that captures the spoken utterance of the first user, a signal associated with an identifier. The signal can be rendered by a signaling device responsive to a determination that the first user is speaking. The identifier can be associated with the first user and/or the first signaling device. The transcription device and the signaling device can be physically distinct. That is, the devices can be separate entities, and remote from one another.

At block 412, the system determines that the first user is a member of the first conversational cluster. This can be based at least in part on determining that the spoken utterance of the first user and the spoken utterance of the second user overlap for at least a threshold period of time. The first conversational cluster includes at least one other participant and does not include the second user.

In some implementations, determining that the first user is a member of the first conversational cluster is further based, at least in part, on determining that the spoken utterance of the first user does not overlap with a spoken utterance from another member of the first conversational cluster.

At block 413, the system generates a transcription of the spoken utterance from the first user in the audio data. The generation of the transcription can be based on performance of automatic speech recognition on the audio data. The generated transcription can thus include recognized text from the spoken utterance of the first user.

At block 414, the system annotates the transcription to indicate that the recognized text from the spoken utterance of the first user is part of the first conversational cluster.

In some implementations, the one or more microphones of the transcription device includes a plurality of spatially distributed microphones (e.g. a beamforming microphone array). The system can thus determine, based on a relative signal strength of the received audio data received at each one of the plurality of spatially distributed microphones, a direction of the first user. The determination that the first user is a member of the first conversational cluster can thus be further based on the determined direction of the first user. The system can annotate the transcription to indicate that the recognized text from the spoken utterance of the first user was received from the determined direction of the first user. Additionally or alternatively, when the one or more microphones of the transcription device includes a beamforming microphone array, the beamforming microphone array can be caused to focus towards the determined position of the first conversational cluster.

At block 415, the system provides the annotated transcription for output. In some implementations, the annotated transcription may be provided for output by rendering the annotated transcription on a display interface (e.g. display 104 of transcription device 102). The annotated transcription may be rendered on the display interface in a streaming manner. For instance, the annotated transcription may be rendered on the display interface during a conversation with minimal delay (e.g. in or near to real time), such that a user viewing the annotated transcription as it is being rendered can follow the conversation(s) occurring in the environment.

In some implementations, the system can also determine, based at least in part on determining that the spoken utterance of the first user and the spoken utterance of the second user overlap for at least the threshold period of time, that the second user is a member of a second conversational cluster (i.e., a conversational cluster including different participants than those of the first conversational cluster). Recognized text corresponding to the spoken utterance of the second user can be determined. The transcription can thus further include the recognized text from the spoken utterance of the second user. The transcription can be annotated to indicate that the recognized text from the spoken utterance of the second user is associated with the second conversational cluster. In some implementations, upon determining that the spoken utterance from the second user is associated with the second conversational cluster, it may instead be determined to bypass generating a transcription of the spoken utterance from the second user.

In some implementations, the system may dynamically update the associations between users (and spoken utterances belonging to those users) and conversational clusters. For instance, the system may determine that the first user has become a member of a second conversational cluster. This can be based, for instance, on determining that a spoken utterance of at least one other member of the first conversational cluster overlaps with a subsequent spoken utterance of the first user for at least a threshold period of time. In some implementations, the threshold period of time to detect an instance of overlap to initially “enter” a conversation cluster, as described, for instance, in relation to block 412 and FIG. 2, may be the same as threshold period of time to detect an instance of overlap to “leave” the conversational cluster, or may have a longer or shorter duration. Additionally or alternatively, it can be determined that the user has become a member of a second conversational cluster based on determining that the subsequent spoken utterance of the first user does not overlap with spoken utterances from members of the second conversational cluster for at least a threshold period of time. The transcription can then be annotated to indicate that recognized text from spoken utterances of the first user received after the first user has been determined to be a member of the second conversational cluster is part of the second conversational cluster.

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform selected aspects of method 410 and/or to implement one or more aspects of signaling device 122 or transcription device 102. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a CD-ROM drive, an optical drive, or removable media cartridges.

Modules implementing the functionality of certain implementations may be stored by file storage subsystem 526 in the storage subsystem 524, or in other machines accessible by the processor(s) 514. Bus subsystem 512 provides a mechanism for letting the various components and subsystems of computer system 510 communicate with each other as intended. Although bus subsystem 512 is shown schematically as a single bus, alternative implementations of the bus subsystem may use multiple buses.

Computer system 510 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure. In a first aspect, a method implemented by one or more processors is provided and includes: receiving audio data that captures a spoken utterance of a first user and a spoken utterance of a second user, the audio data being generated by one or more microphones of a transcription device; determining, based on determining that the spoken utterance of the first user and the spoken utterance of the second user overlap for at least a threshold period of time, that the first user is a member of a first conversational cluster, wherein the first conversational cluster includes at least one other participant and does not include the second user; generating a transcription based on performance of automatic speech recognition on the audio data, the transcription comprising recognized text from the spoken utterance of the first user; annotating the transcription to indicate that the recognized text from the spoken utterance of the first user is part of the first conversational cluster; and providing the annotated transcription for output.

These and other implementations of technology disclosed herein can optionally include one or more of the following features.

In some implementations, the method may further include: determining, based on determining that the spoken utterance of the first user and the spoken utterance of the second user overlap for at least the threshold period of time, that the second user is a member of a second conversational cluster; wherein the transcription may further include recognized text from the spoken utterance of the second user, and annotating the transcription further includes annotating the transcription to indicate that the recognized text from the spoken utterance of the second user is part of the second conversational cluster.

In some implementations, determining that the first user is a member of the first conversational cluster is further based on determining that the spoken utterance of the first user does not overlap with a spoken utterance from another member of the first conversational cluster.

In some implementations, the method may further include: subsequent to determining that the first user is a member of the first conversational cluster: determining that the first user has become a member of a second conversational cluster; and annotating the transcription to indicate that recognized text from spoken utterances, of the first user, received after the first user has been determined to be a member of the second conversational cluster is part of the second conversational cluster.

In some implementations, determining that the first user has become a member of the second conversational cluster is based on one or both of: determining that a spoken utterance of at least one other member of the first conversational cluster overlaps with a subsequent spoken utterance of the first user for at least a second threshold period of time, and determining that the subsequent spoken utterance of the first user does not overlap with spoken utterances from members of the second conversational cluster for at least a third threshold period of time.

In some implementations, determining that the first user is a member of the first conversational cluster is further based on a determined direction and/or distance of the first user relative to the transcription device.

In some implementations, the method may further include annotating the transcription to indicate that the recognized text from the spoken utterance of the first user was received from a determined direction and/or distance relative to the transcription device.

In some implementations, the one or more microphones of the transcription device may include a plurality of spatially distributed microphones, and the method may further include determining a direction of the first user relative to the transcription device based on a relative signal strength of the received audio data received at each one of the plurality of spatially distributed microphones.

In some implementations, the one or more microphones of the transcription device may include a beamforming microphone array, and the method may further include: determining a direction of the first conversational cluster; and causing the beamforming microphone array to focus towards a determined direction of the first conversational cluster.

In some implementations, the method may further include determining that the spoken utterance of the first user is provided by the first user based on one or more voice characteristics of the spoken utterance.

In some implementations, the method may further include receiving, whilst receiving the audio data that captures the spoken utterance of the first user, a signal associated with an identifier, wherein the signal is rendered by a first signaling device responsive to a determination that the first user is speaking and the identifier is associated with the first user and/or the first signaling device, and wherein the transcription device and the first signaling device are physically distinct; determining that the spoken utterance of the first user is provided by the first user based on receiving the signal whilst receiving the audio data that captures the spoken utterance of the first user.

In some implementations, providing the annotated transcription for output may include rendering the annotated transcription on a display interface.

In some versions of those implementations, the annotated transcription is rendered on the display interface in a streaming manner.

In some additional or alternative versions of those implementations, rendering the annotated transcription on the display interface may include rendering at least one graphical element, the at least one graphical element comprising a first color associated with the first user and/or with the first conversational cluster. In some versions of those implementations, the graphical element may include the recognized text from the spoken utterance of the first user.

In some additional or alternative versions of those implementations, rendering the annotated transcription on the display interface may include: determining a confidence that the spoken utterance of the first user was provided by the first user; determining a modified version of a first color associated with the first user based on the determined confidence; and rendering at least one graphical element, the at least one graphical element comprising the modified version of the first color. In some versions of those implementations, the method may further include determining an additional confidence that the spoken utterance of the first user was provided by an additional user, wherein determining the modified version of the first color includes determining a mixture of the first color and a second color associated with the additional user based on the determined confidence that the spoken utterance of the first user was provided by the first user and the determined additional confidence that the spoken utterance of the second user was provided by the additional user.

In some additional or alternative versions of those implementations, rendering the annotated transcription on the display interface may further include: determining a confidence that the first user is a member of the first conversational cluster; determining a modified version of a first color associated with the first conversational cluster based on the determined confidence; rendering at least one graphical element, the at least one graphical element comprising the modified version of the first color. In some versions of those implementations, the method may further include determining an additional confidence that the first user is a member of a second conversational cluster, wherein determining the modified version of the first color includes determining a mixture of the first color and a second color associated with the second conversational cluster based on the determined confidence that first user is a member of the first conversational cluster and the determined additional confidence that the first user is a member of the second conversational cluster.

In a second aspect, a system is provided and includes: one or more processors; and memory storing instructions that, in response to execution by the one or more processors, cause the one or more processors to: receive audio data that captures a spoken utterance of a first user and a spoken utterance of a second user, the audio data being generated by one or more microphones of a transcription device; determine, based on determining that the spoken utterance of the first user and the spoken utterance of the second user overlap for at least a threshold period of time, that the first user is a member of a first conversational cluster, wherein the first conversational cluster includes at least one other participant and does not include the second user; generate a transcription based on performance of automatic speech recognition on the audio data, the transcription comprising recognized text from the spoken utterance of the first user; annotate the transcription to indicate that the recognized text from the spoken utterance of the first user is part of the first conversational cluster; and provide the annotated transcription for output.

In some implementations, the system may further include memory storing instructions that, in response to execution by the one or more processors, cause the one or more processors to perform operations corresponding to any one of the methods of the first aspect.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

1. A method implemented by one or more processors, the method comprising:
receiving audio data that captures a spoken utterance of a first user and a spoken utterance of a second user, the audio data being generated by one or more microphones of a transcription device;
determining, based on determining that the spoken utterance of the first user and the spoken utterance of the second user overlap for at least a threshold period of time, that the first user is a member of a first conversational cluster, wherein the first conversational cluster includes at least one other participant and does not include the second user;
generating a transcription based on performance of automatic speech recognition on the audio data, the transcription comprising recognized text from the spoken utterance of the first user;
annotating the transcription to indicate that the recognized text from the spoken utterance of the first user is part of the first conversational cluster; and
providing the annotated transcription for output.

2. The method of claim 1, further comprising:
determining, based on determining that the spoken utterance of the first user and the spoken utterance of the second user overlap for at least the threshold period of time, that the second user is a member of a second conversational cluster;
wherein the transcription further comprises recognized text from the spoken utterance of the second user, and annotating the transcription further comprises annotating the transcription to indicate that the recognized text from the spoken utterance of the second user is part of the second conversational cluster.

3. The method of claim 1, wherein determining that the first user is a member of the first conversational cluster is further based on determining that the spoken utterance of the first user does not overlap with a spoken utterance from another member of the first conversational cluster.

4. The method of claim 1, further comprising:
subsequent to determining that the first user is a member of the first conversational cluster:
determining that the first user has become a member of a second conversational cluster; and
annotating the transcription to indicate that recognized text from spoken utterances, of the first user, received after the first user has been determined to be a member of the second conversational cluster is part of the second conversational cluster.

5. The method of claim 4, wherein determining that the first user has become a member of the second conversational cluster is based on one or both of:
determining that a spoken utterance of at least one other member of the first conversational cluster overlaps with a subsequent spoken utterance of the first user for at least a second threshold period of time, and
determining that the subsequent spoken utterance of the first user does not overlap with spoken utterances from members of the second conversational cluster for at least a third threshold period of time.

6. The method of claim 1, wherein determining that the first user is a member of the first conversational cluster is further based on a determined direction and/or distance of the first user relative to the transcription device.

7. The method of claim 1, further comprising:
annotating the transcription to indicate that the recognized text from the spoken utterance of the first user was received from a determined direction and/or distance relative to the transcription device.

8. The method of claim 1, wherein the one or more microphones of the transcription device comprise a plurality of spatially distributed microphones, and further comprising:
determining a direction of the first user relative to the transcription device based on a relative signal strength of the received audio data received at each one of the plurality of spatially distributed microphones.

9. The method of claim 1, wherein the one or more microphones of the transcription device comprise a beamforming microphone array, and further comprising:
determining a direction of the first conversational cluster; and
causing the beamforming microphone array to focus towards a determined direction of the first conversational cluster.

10. The method of claim 1, further comprising:
determining that the spoken utterance of the first user is provided by the first user based on one or more voice characteristics of the spoken utterance.

11. The method of claim 1, further comprising:
receiving, whilst receiving the audio data that captures the spoken utterance of the first user, a signal associated with an identifier, wherein the signal is rendered by a first signaling device responsive to a determination that the first user is speaking and the identifier is associated with the first user and/or the first signaling device, and wherein the transcription device and the first signaling device are physically distinct; and
determining that the spoken utterance of the first user is provided by the first user based on receiving the signal whilst receiving the audio data that captures the spoken utterance of the first user.

12. The method of claim 1, wherein providing the annotated transcription for output comprises rendering the annotated transcription on a display interface.

13. The method of claim 12, wherein the annotated transcription is rendered on the display interface in a streaming manner.

14. The method of claim 12, wherein rendering the annotated transcription on the display interface comprises:
rendering at least one graphical element, the at least one graphical element comprising a first color associated with the first user and/or with the first conversational cluster.

15. The method of claim 14, wherein the graphical element comprises the recognized text from the spoken utterance of the first user.

16. The method of claim 12, wherein rendering the annotated transcription on the display interface comprises:
determining a confidence that the spoken utterance of the first user was provided by the first user;
determining a modified version of a first color associated with the first user based on the determined confidence; and
rendering at least one graphical element, the at least one graphical element comprising the modified version of the first color.

17. The method of claim 16, further comprising:
determining an additional confidence that the spoken utterance of the first user was provided by an additional user, wherein determining the modified version of the first color comprises determining a mixture of the first color and a second color associated with the additional user based on the determined confidence that the spoken utterance of the first user was provided by the first user and the determined additional confidence that the spoken utterance of the second user was provided by the additional user.

18. The method of claim 12, wherein rendering the annotated transcription on the display interface comprises:
determining a confidence that the first user is a member of the first conversational cluster;
determining a modified version of a first color associated with the first conversational cluster based on the determined confidence; and
rendering at least one graphical element, the at least one graphical element comprising the modified version of the first color.

19. The method of claim 18, further comprising:
determining an additional confidence that the first user is a member of a second conversational cluster, wherein determining the modified version of the first color comprises determining a mixture of the first color and a second color associated with the second conversational cluster based on the determined confidence that first user is a member of the first conversational cluster and the determined additional confidence that the first user is a member of the second conversational cluster.

20. A system comprising:
one or more processors; and
memory storing instructions that, in response to execution by the one or more processors, cause the one or more processors to:
receive audio data that captures a spoken utterance of a first user and a spoken utterance of a second user, the audio data being generated by one or more microphones of a transcription device;
determine, based on determining that the spoken utterance of the first user and the spoken utterance of the second user overlap for at least a threshold period of time, that the first user is a member of a first conversational cluster, wherein the first conversational cluster includes at least one other participant and does not include the second user;
generate a transcription based on performance of automatic speech recognition on the audio data, the transcription comprising recognized text from the spoken utterance of the first user;
annotate the transcription to indicate that the recognized text from the spoken utterance of the first user is part of the first conversational cluster; and
provide the annotated transcription for output.

21. (canceled)

22. (canceled)
